(19) United States
(12) Patent Application Publication
(10) Pub. No.: US 2025/0124614 A1
(43) Pub. Date: Apr. 17, 2025

(54) CONTROL DEVICE, SYSTEM, CONTROL METHOD FOR DISPOSING VIRTUAL OBJECT IN ACCORDANCE WITH POSITION OF USER

(71) Applicant: CANON KABUSHIKI KAISHA, Tokyo (JP)

(72) Inventor: MASATO UCHIHARA, Tokyo (JP)

(21) Appl. No.: 18/991,084

(22) Filed: Dec. 20, 2024

Related U.S. Application Data
(63) Continuation of application No. PCT/JP2023/013780, filed on Apr. 3, 2023.

(30) Foreign Application Priority Data
Jun. 29, 2022 (JP) 2022-104382

(51) Int. Cl. G06T 11/00; G06T 7/50; G06T 7/70; G06V 10/776; G06V 20/20

(52) U.S. Cl. CPC G06T 11/00; G06T 7/50; G06T 7/70; G06V 10/776; G06V 20/20; G06T 2207/30196

(57) ABSTRACT

A control device that controls a display device to be worn by a first user in a first real space controls the display device so that a virtual object seemingly disposed at a position in the first real space corresponding to a position of a second user in a second real space and a range-display object indicating a range, in which the virtual object is movable in the first real space, are displayed.

### CROSS-REFERENCE TO RELATED APPLICATIONS

This application is a Continuation of International Patent Application No. PCT/JP2023/013780, filed Apr. 3, 2023, which claims the benefit of Japanese Patent Application No. 2022-104382, filed Jun. 29, 2022, both of which are hereby incorporated by reference herein in their entirety.

### BACKGROUND OF THE INVENTION

### FIELD OF THE INVENTION

The present invention relates to a control device, a system, and a control method.

### BACKGROUND ART

In head mount displays (HMD) of a plurality of users located in real spaces (actual spaces) different among one another, there is a case where the same virtual object (AR object) is displayed. In addition, there is a case where a virtual person (avatar) disposed in accordance with the position of a user in a second real space is displayed in the HMD worn by a user located in a first real space. In this case, if the size of the first real space and the size of the second real space are different, disposition of the avatar is restricted in the HMD.

PTL 1 discloses an art in which, in a case where a virtual object is disposed at a position where the virtual object should not be disposed, a user is notified of the disposition of the virtual object at the position where the virtual object should not be disposed.

### CITATION LIST

### Patent Literature

PTL 1 Japanese Patent Application Publication No. 2018-106298

As described above, in PTL 1, after a virtual object is disposed at a position where the virtual object should not be disposed, a user is notified of the disposition of the virtual object at the position where the virtual object should not be disposed. Thus, the user cannot ascertain in advance that there was a possibility that the virtual object would have been disposed at a position where the virtual object should not be disposed.

### SUMMARY OF THE INVENTION

Thus, the present invention has an object to provide an art that enables to ascertain a possibility that a virtual object is disposed at an inappropriate position, when the virtual object is to be disposed in accordance with a position of a user.

An aspect of the present invention is a control device for controlling a display device to be worn by a first user in a first real space, the control device including one or more processors and/or circuitry configured to: execute control processing of controlling the display device such that a virtual object disposed at a position in the first real space corresponding to a position of a second user in a second real space and a range-display object indicating a range, in which the virtual object is movable in the first real space, are displayed, wherein the range, in which the virtual object is movable in the first real space, corresponds to an effective range; and the effective range is a range in which the second user is movable in the second real space and in which the second user is detectable from a picked-up image acquired by an imaging device through imaging in the second real space.

An aspect of the present invention is a control method for controlling a display device to be worn by a first user in a first real space, the method including: a first control step of controlling the display device such that a virtual object disposed at a position of the first real space corresponding to a position of a second user in a second real space is displayed; and a second control step of controlling the display device such that a range-display object indicating a range, in which the virtual object is movable in the first real space is displayed, wherein the range, in which the virtual object is movable in the first real space, corresponds to an effective range; and the effective range is a range, in which the second user is movable, in the second real space and, in which the second user is detectable from a picked-up image acquired by imaging by the imaging device, in the second real space.

Further features of the present invention will become apparent from the following description of exemplary embodiments with reference to the attached drawings.

### BRIEF DESCRIPTION OF THE DRAWINGS

FIG. 1 is a diagram for explaining a system according to an Embodiment 1.

FIG. 2A is a diagram for explaining a use image of the system according to the Embodiment 1.

FIG. 2B is a diagram illustrating a display example of an HMD according to the Embodiment 1.

FIG. 2C is a diagram illustrating a synthesized image generated by a camera according to the Embodiment 1.

FIG. 3A is a diagram illustrating an example of a real space according to the Embodiment 1.

FIG. 3B is a diagram for explaining a problem according to the Embodiment 1.

FIG. 4A and FIG. 4B are diagrams for explaining a range in which an avatar according to the Embodiment 1 is movable.

FIG. 5 is a configuration diagram of a video see-through type HMD according to the Embodiment 1.

FIG. 6 is a configuration diagram of an optical see-through type HMD according to the Embodiment 1.

FIG. 7 is a configuration diagram of a camera according to the Embodiment 1.

FIG. 8 is a diagram for explaining a position of a user according to the Embodiment 1.

FIG. 9 is a flowchart illustrating detection processing of range information according to the Embodiment 1.

FIG. 10 is a diagram illustrating a list related to an obstacle object according to the Embodiment 1.

FIG. 11 is a diagram for explaining an effective range according to the Embodiment 1.

FIG. 12A and FIG. 12B are diagrams for explaining gradation display of the effective range according to the Embodiment 1.

FIG. 13 is a diagram for explaining range information according to the Embodiment 1.

FIG. 14 is a diagram for explaining a system according to an Embodiment 2.

### DESCRIPTION OF THE EMBODIMENTS

Embodiments of the present invention will be explained by using diagrams in the following.

First, an art related to an HMD (Head-Mount Display) will be explained. In the HMD, a smartphone, a tablet terminal and the like, arts such as AR or MR are used. Here, in the HMD that can be worn on the head of a user, a display is disposed in front of the eye of the user. Thus, the HMD can display useful information according to a use scene and can give a deep sense of immersion to the user.

In the HMDs, there are optical see-through type HMD using a transparent (translucent) display and a video see-through type HMD using an opaque display.

In the optical see-through type HMD, a user can visually recognize both an image and incident light from an external world at the same time. That is, in the optical see-through type HMD, the user can visually recognize the external space through the display. By using the optical see-through type HMD, while experiencing an event (a concert, an athletic meet and the like) via the HMD at a certain spot, the user can acquire various types of information related to a person or an object to which the user is paying attention from the display on the HMD.

On the other hand, the video see-through type HMD can display a virtual space on a display in front of the eye of a user or can display an image acquired by a camera mounted on the HMD on the display. As a result, the HMD, for example, can display various types of information superposed on the image acquired by picking up an actual space (real space) in which the user is located.

### Embodiment 1

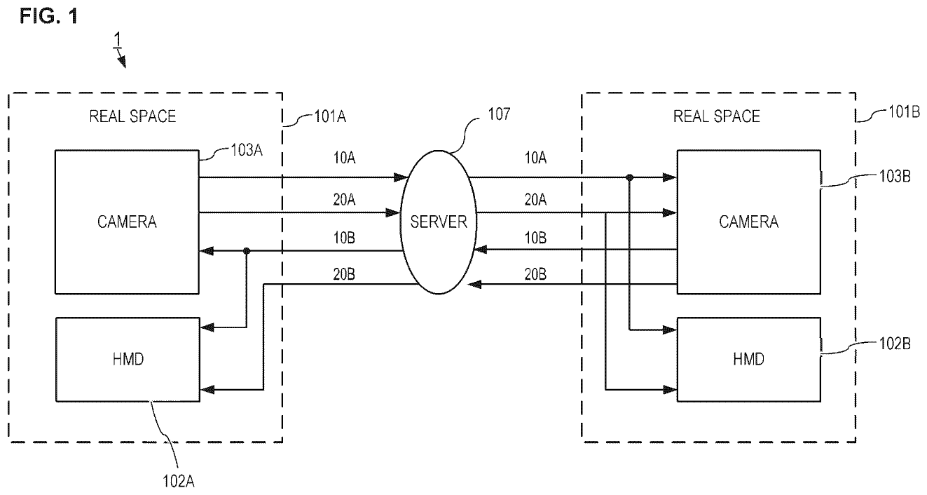

FIG. 1 is a diagram for explaining a system 1 (display system; control system) according to the Embodiment 1. In FIG. 1, two real spaces 101 (101A, 101B) are actual spaces (actual spaces) where two users 100 (100A, 100B) are located.

The system 1 has an HMD 102A and a camera 103B in the real space 101A. The system 1 has an HMD 102B and a camera 103B in the real space 101B. Note that the HMD 102A and the HMD 102B have the same configuration as the other, and the camera 103A and the camera 103B have the same configuration as the other. Thus, in the following, contents explained for one of the HMD 102A and the HMD 102B will not be explained for the other in principle. Similarly, contents explained for one of the camera 103A and the camera 103B will not be explained for the other in principle.

The HMD 102A is an HMD worn by the user 100A (user located at the real space 101A). Explanation will be made on the premise that the HMD 102A is a video see-through type HMD unless otherwise explained.

The camera 103A is an imaging device installed at a fixed position of the real space 101A. The camera 103A picks up an image of the real space 101A and the user 100A in the real space 101A. The camera 103A detects a position, attitude and an expression of the face (laughing expression, angry expression, no expression and the like) of the user 100A from the image (picked-up image) acquired by imaging the user 100A (real space 101A). And the camera 103A transmits the information of the detection result (the position, attitude and the expression of the face of the user 100A) as state information 10A to the server 107.

At this time, the state information 10A is transmitted to the HMD 102B via the server 107. Then, the HMD 102B controls the avatar (the position, attitude, an expression and the like of the avatar) to be displayed on the display (display unit) in accordance with the received state information 10A. As a result, the user 100B wearing the HMD 102B can recognize the position, attitude, and a change in the expression of the user 100A (opponent user) on a real-time basis.

In addition, the camera 103A detects range information 20A indicating a range (effective range) in which the user 100A is movable and the user 100A can be detected from the picked-up image in the real space 101A. And the camera 103A transmits the range information 20A to the HMD 102B via the server 107. In this case, the HMD 102B displays the range in which the avatar is movable on the display on the basis of the received range information 20A. Details of the state information 10 (10A, 10B) and the range information 20 (20A, 20B) will be described later.

### Use Image of System

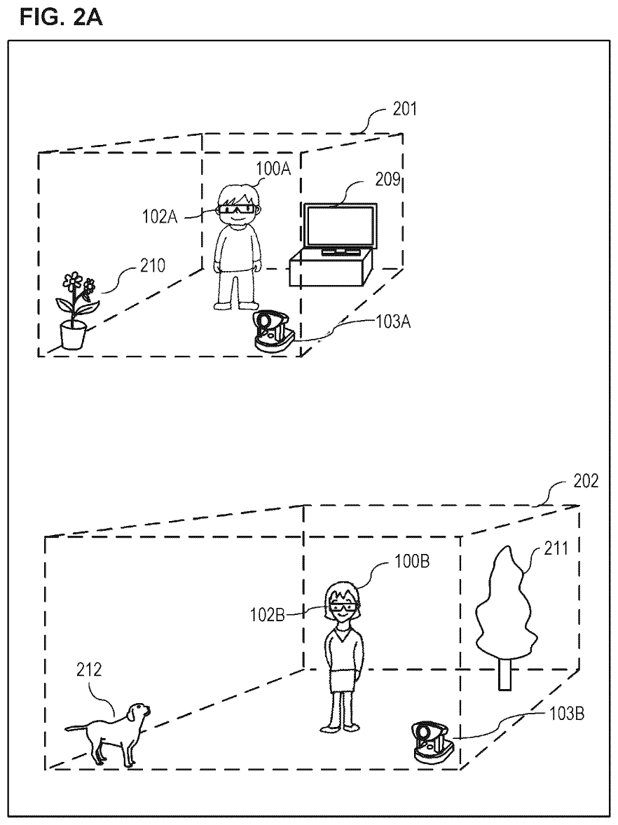

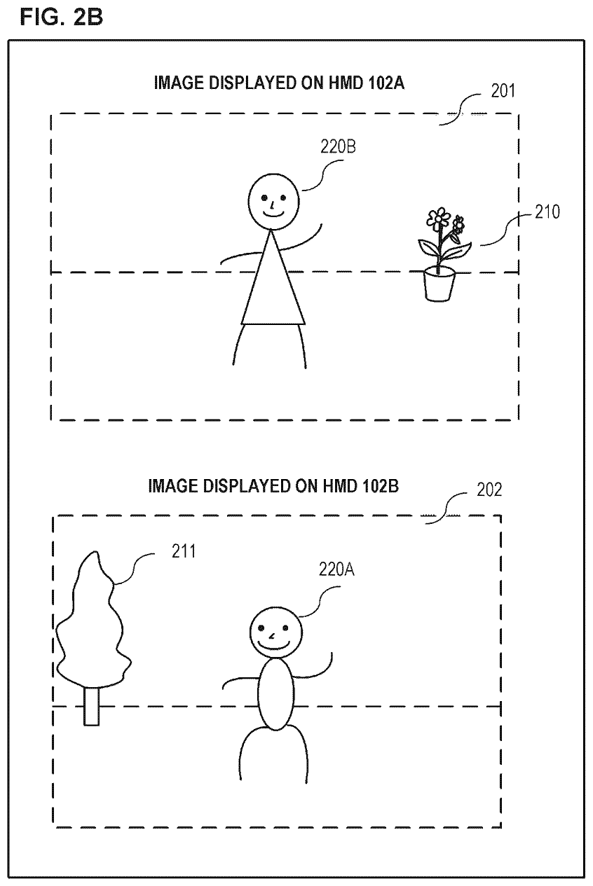

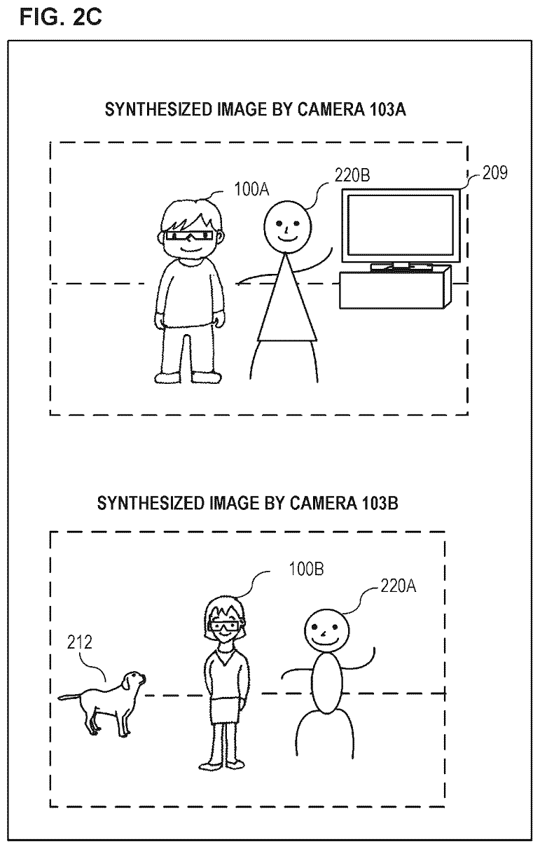

With reference to FIG. 2A to FIG. 2C, a use image of the system 1 will be explained.

FIG. 2A illustrates such a situation that the two users 100 (100A, 100B) are using the HMDs 102 (102A, 102B) in the real spaces 101 (a room 201, which is the real space 101A and a garden 202, which is the real space 101B) different from each other, respectively.

The camera 103A is disposed at a corner of the room 201. The camera 103B is disposed at a corner of the garden 202. In addition, a TV set 209 and a foliage plant 210 are disposed in the room 201. In the garden 202, a garden tree 211 and a dog 212 are disposed.

Here, the “range in which the user 100A is movable in the room 201 (effective range of the user 100A), when the state (position, attitude, expressions of the face and the like) of the user 100A is to be reflected to the avatar of the user 100A”, will be explained. The effective range of the user 100A is a range acquired by removing, from the room 201, the range in which the TV set 209 and the foliage plant 210 are disposed and a range in which the camera 103A can detect the user 100A. In addition, the effective range of the user 100B is a range acquired by removing, from the garden 202, the range in which the garden tree 211 and the dog 212 are disposed and a range in which the camera 103B can detect the user 100B.

FIG. 2B illustrates an example of an image displayed on the HMD 102 (102A, 102B) of the user 100 (100A, 100B). On the HMD 102A, an avatar 220B of the user 100B is displayed with the room 201 as a background. In addition, on the HMD 102B, an avatar 220A of the user 100A is displayed with the garden 202 as a background. The avatar displayed on the HMD 102 changes its position, attitude, expression and the like interlockingly with a state change of the other user (user different from the user wearing the HMD 102 concerned).

Here, in the image displayed on the HMD 102A, the avatar 220B is disposed so that a relative position of the user 100B with respect to the camera 103B and the relative position of the avatar 220B with respect to the camera 103A are matched. Similarly, in the image displayed on the HMD 102B, the avatar 220A is disposed so that the relative position of the user 100A with respect to the camera 103A and the relative position of the avatar 220A with respect to the camera 103B are matched.

FIG. 2C illustrates an example of an image acquired by synthesizing the avatar with the image (picked-up image) of the real space 101 picked up by the camera 103 (camera 103A, camera 103B). Here, the camera 103 (103A, camera 103B) images only the user and the background. The camera 103 generates such a synthesized image that the user and the avatar are present in the same real space by synthesizing the avatar (avatar generated on the basis of the state information of the other user) and the picked-up image. The synthesized image generated as above is recorded in the server 107 or delivered to an external device via the server 107. As a result, the user and a third party other than the user can view the synthesized image looking as if the user and the avatar are playing together. Note that, in the following, the synthesized image generated by the camera 103 is called a “camera synthesized image”.

In addition, in the camera synthesized image generated by the camera 103A, the avatar 220B is disposed so that the relative position of the user 100B with respect to the camera 103B and the relative position of the avatar 220B with respect to the camera 103A are matched. Similarly, in the camera synthesized image generated by the camera 103B, the avatar 220A is disposed so that the relative position of the user 100A with respect to the camera 103A and the relative position of the avatar 220A with respect to the camera 103B are matched.

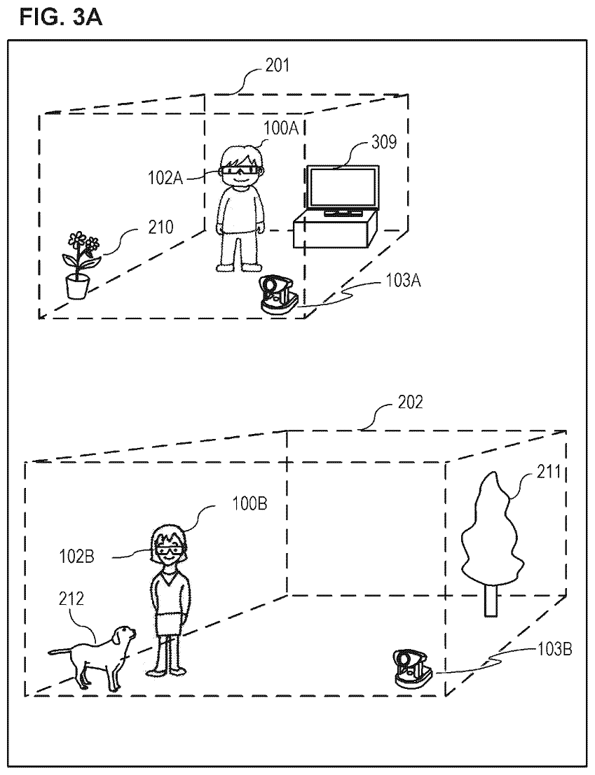

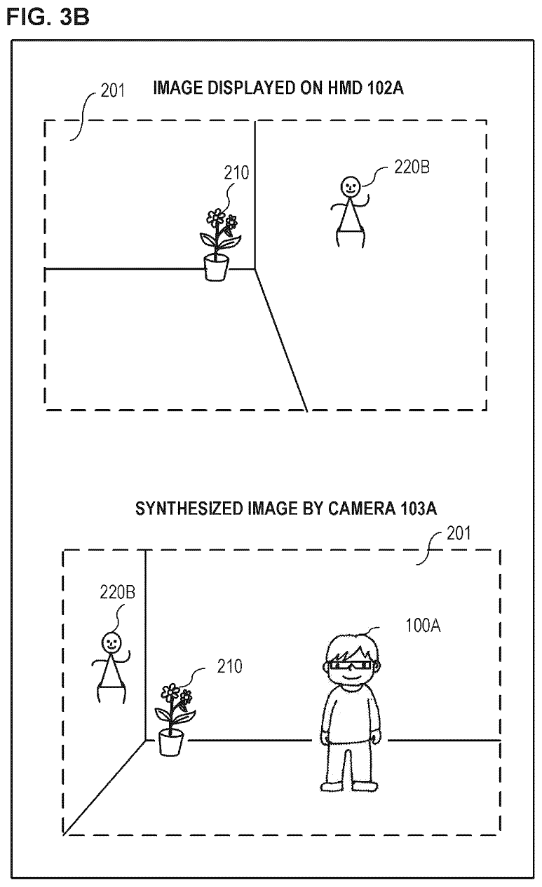

Thus, if an area of the real space 101 located for each user is different, the image displayed on the HMD 102 and the camera synthesized image look unnatural in some cases. For example, as shown in FIG. 3A, such a case is assumed that the user 100B in the garden 202 has moved to a position at the corner of the garden 202 corresponding to the outside of the range of the room 201 (effective range of the user 100A in the room 201). In this case, in the image displayed on the HMD 102A of the user 100A, as shown in FIG. 3B, the avatar 220B of the user 100B is disposed outside of the room 201 of the user 100A. In addition, in the camera synthesized image generated by the camera 103A, too, as shown in FIG. 3B, the avatar 220B of the user 100B is disposed outside the room 201.

Note that the user 100B cannot grasp the situation of the room 201 of the user 100A. Thus, the user 100B does not notice that the disposition of the avatar 220B is unnatural in the image displayed on the HMD 102A and the camera synthesized image generated by the camera 103A. That is, if the user 100B does not grasp the details of the room 201 by actually looking at the room 201 or the like, the user 100B cannot grasp the range (range in which the user himself/herself may move) in which the avatar 220B is not disposed at an unnatural position.

In order to solve this problem, in the Embodiment 1, on the basis of the range information 20B in the real space 101B, the HMD 102 that displays the range in which the avatar 220B is movable as a range in which movement of the user 100A is allowed will be explained.

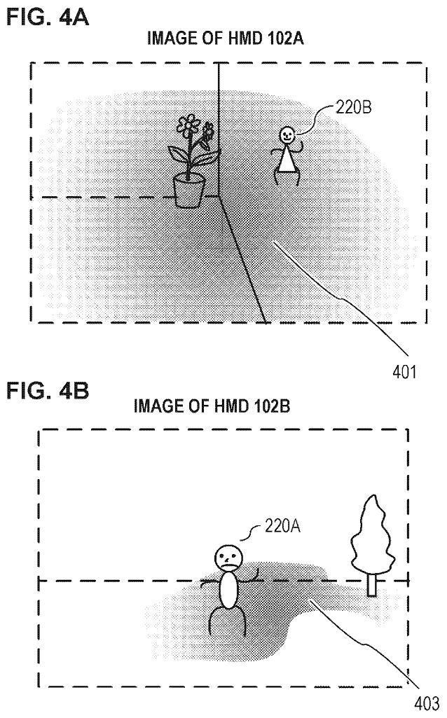

FIG. 4A and FIG. 4B illustrate display examples of the range in which the avatar displayed on the HMD 102 is movable. In FIG. 4A, in the HMD 102A, a virtual object (hereinafter, called a “range-display object”) 401 that illustrates a range in which the avatar 220B of the user 100B is movable by gradation display (light-and-shade display) is displayed. In FIG. 4B, in the HMD 102B, a range-display object 403 illustrating a range in which the avatar 220A of the user 100A is movable by the gradation display is displayed. Note that, though it will be described later, the darker the range is in the range-display object 403, with the higher accuracy the detection of the state of the user 100A is performed in the range of the real space 101A corresponding to the range and thus, the avatar 220A operates smoothly. In addition, the range-display object 403 has transmissivity, and the user 100B can see the real space 101B (image of the real space 101B) by transmitting the range-display object 403.

In addition, for example, the user 100A recognizes the range-display object 401 as shown in FIG. 4A from the display of the HMD 102A and begins to behave within the range of the real space 101A shown by the gradation display. As a result, in the image displayed on the HMD 102B and the synthesized image synthesized by the camera 103B, such disposition of the avatar 220A at an unnatural position can be avoided. Specifically, since the range of the range-display object 401 corresponds to the effective range of the user 100B, when the user 100A moves within the range of the range-display object 401, the avatar 220A begins to move only in the effective range of the user 100B.

### Constitution of HMD

Subsequently, an internal constitution of the HMD 102 (102A, 102B) will be explained. In the above, the HMD 102 was explained on the premise that it was the video see-through time HMD. However, the HMD 102 may be either one of an optical see-through type HMD and a video see-through type HMD. Here, each constitution of the HMD 102 is controlled by a control unit (not shown). That is, the control unit controls the entire HMD 102 (display device).

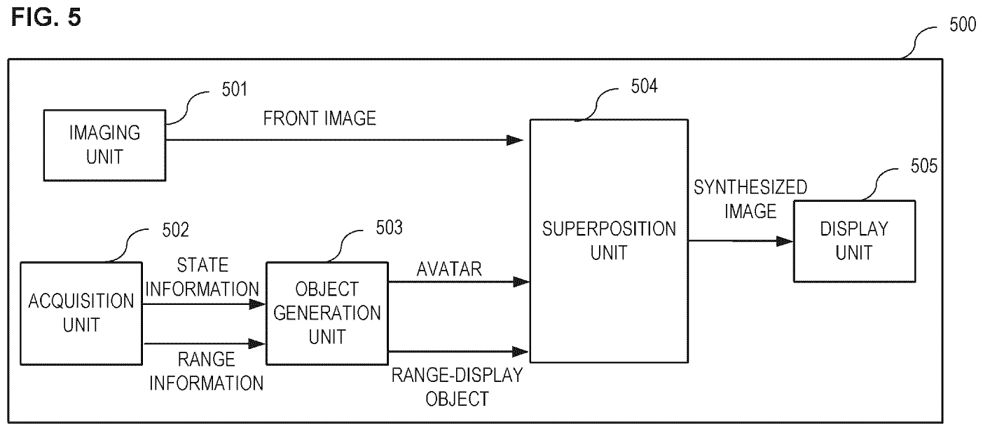

First, by using FIG. 5, a case in which the HMD 102 is a video see-through type HMD 500 will be explained. The HMD 500 has an imaging unit 501, an acquisition unit 502, an object generation unit 503, a superposition unit 504, a display unit 505. In the following, explanation will be made on the premise that the HMD 500 is the HMD 102A worn by the user 100A.

The imaging unit 501 is an imaging device (camera) which acquires an image acquired by imaging a front (front surface) of the user 100A (hereinafter called “front image”). For the imaging unit 501, an imaging device having an imaging field angle (from a wide angle to a standard imaging field angle) close to the field of view of the user 100A in general is used.

The acquisition unit 502 acquires the state information 10B and the range information 20B from the camera 103B of the user 100B via the server 107. The acquisition unit 502 transmits the state information 10B and the range information 20B to the object generation unit 503.

The position of the user 100B indicated by the state information 10B is a relative position of the user 100B with respect to the camera 103B. The range information 20B is information indicating the effective range of the user 100B (the range in which the user 100B is movable in the real space 101B, and the range in which the camera 103B can detect the user 100B) by the relative position from the camera 103B. In addition, the range information 20B includes information on a gradation level (density) of the position concerned in accordance with detection accuracy of the state of the user 100B at each position of the effective range.

The object generation unit 503 generates the avatar 220B (image of the avatar 220B) on the basis of the state information 10B received from the acquisition unit 502. In addition, the object generation unit 503 generates the range-display object (image of the range-display object) indicating the range in which the avatar 220B is movable on the basis of the range information 20B received from the acquisition unit 502. Specifically, the object generation unit 503 generates such a range-display object that can cover the range of the front image (real space 101A) corresponding to the effective range indicated by the range information 20B. In addition, the object generation unit 503 colors each position of the range-display object in accordance with the gradation level of the position in the effective range corresponding to the position concerned.

The superposition unit 504 generates a synthesized image (see FIG. 4A and FIG. 4B) in which the avatar 220B (image of the avatar 220B) and the range-display object (image of the range-display object) superposed on the image (front image) that the imaging unit 501 acquired by imaging the front. Then, the superposition unit 504 outputs the synthesized image on the display unit 505.

At this time, the superposition unit 504 disposes the avatar 220B at the position (position in the front image) in accordance with the position of the user 100B indicated by the state information 10B. Specifically, the superposition unit 504 disposes the avatar 220B so that the relative position of the user 100B with respect to the camera 103B and the relative position of the avatar 220B with respect to the camera 103A are matched. Thus, for example, the superposition unit 504 acquires the relative position of the camera 103A with respect to the HMD 500 in advance and disposes the avatar 220B on the basis of the relative position and the state information 10B.

The display unit 505 is a display provided in front of the eyes of the user. The display unit 505 displays a synthesized image.

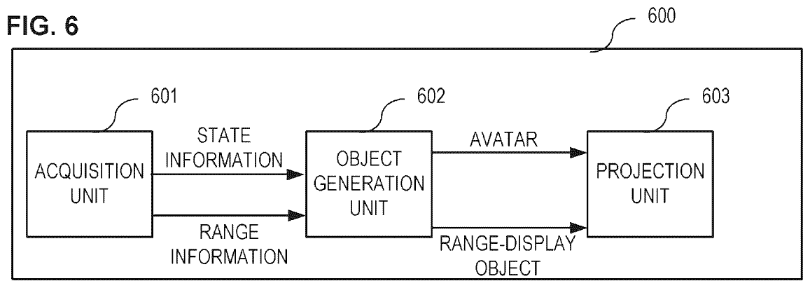

By using FIG. 6, such a case that the HMD 102 is the optical see-through type HMD 600 will be explained. The HMD 600 has an acquisition unit 601, an object generation unit 602, and a projection unit 603. In the following, explanation will be made on the premise that the HMD 600 is the HMD 102A worn by the user 100A.

Note that, in the optical see-through type HMD 600, the user can visually recognize directly the real space 101A via the display surface (display; glass). Thus, the HMD 600 does not have the imaging unit 501.

The acquisition unit 601 acquires the state information 10B and the range information 20B from the camera 103B of the user 100B via the server 107.

The object generation unit 602 generates the avatar 220B (image of the avatar 220B) and the range-display object similarly to the video see-through type HMD 500.

The projection unit 603 projects the avatar 220B and the range-display object to an optical element (such as a prism) installed in the display. At this time, the projection unit 603 projects (disposes) the avatar 220B at a position (position in the display) according to the position of the user 100B indicated by the state information 10B. As a result, the user can look at (recognize) the space in which the avatar 220B and the range-display object are disposed in the real space 101A.

Note that, if the HMD 102 includes the constitutions shown in FIG. 5 and FIG. 6, the shape of the HMD 102 may be an arbitrary shape such as a goggle shape, a glasses shape, a contact lens shape and the like.

### Constitution of Camera

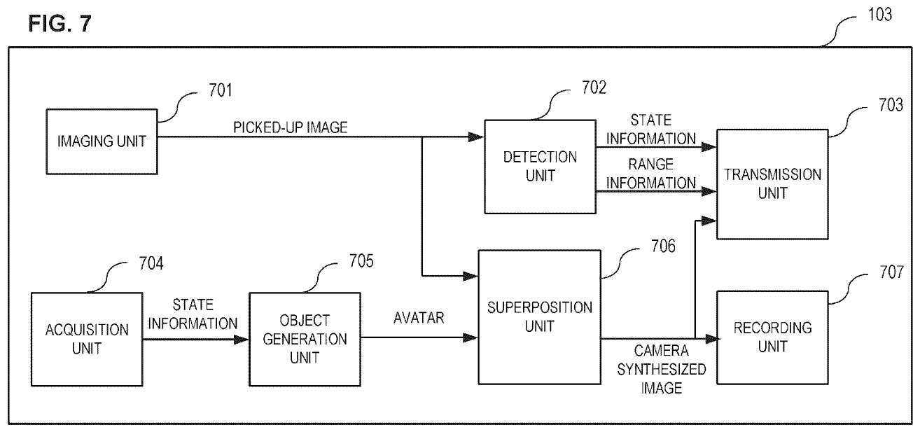

With reference to FIG. 7, an internal constitution of the camera 103 (103A, 103B) will be explained. In the following, the camera 103A which picks up an image of the user 100A will be explained, but the camera 103B has the configuration similar to that of the camera 103A.

An imaging unit 701 picks up an image of the user 100A in the real space 101A. The imaging unit 701 can pick up an image in a wide range of the real space 101A, for example.

A detection unit 702 detects the user 100A in the real space 101A on the basis of an image (picked-up image) of the user 100A picked up by the imaging unit 701. Then, the detection unit 702 acquires information (state information 10A and the range information 20A) of the user 100A on the basis of the picked-up image. Note that instead of acquiring the range information 20A on the basis of the picked-up image, the detection unit 702 may acquire the range information 20A acquired at the previous use of the camera 103A from a recording unit 707 or the like, for example.

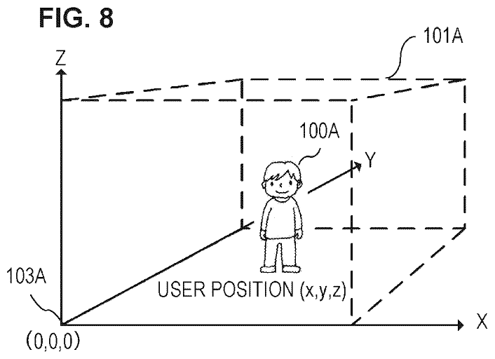

The state information 10A is information related to the state (the position, attitude, direction of the face, expression of the face and the like) of the user 100A. The position of the user 100A is, as shown in FIG. 8, expressed by a coordinate position where the user 100A was detected in the coordinate space with the position of the camera 103A placed in the real space 101A as an origin (0, 0, 0). Regarding the attitude of the user 100A, it is estimated by using an art of Deep Learning or the like on the basis of the coordinate positions of the four limbs of the user 100A in the coordinate space shown in FIG. 8. Regarding the direction of the face, by assuming that such a state that the face of the user 100A is opposed to the camera 103A is a “state facing the front”, it is detected on the basis of which of the upper, lower, right and left the face is directed. Regarding the expression of the face, it is estimated from detection results of how widely the eyes are opened or the position of the corner of the mouth of the user 100A. While the imaging unit 701 is picking up an image of the user 100A, the detection unit 702 detects the position, attitude, direction of the face, and expression of the face of the user 100A at a certain rate (cycle) and updates the state information 10A.

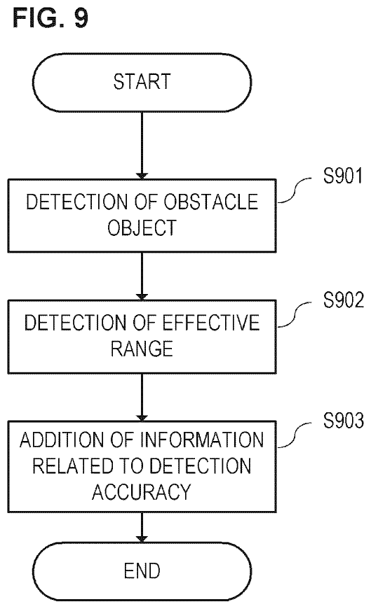

The range information 20A is information indicating an effective range (range in which the user 100A can move in the real space 101A and range in which the user 100A can be detected by the camera 103A) of the user 100A. The detection method of the range information 20A will be described later by using a flowchart in FIG. 9.

The transmission unit 703 transmits the state information 10A and the range information 20A to the server 107. The transmission unit 703 is a communication device. In addition, the transmission unit 703 transmits the camera synthesized image generated by the superposition unit 706 to the server 107.

The acquisition unit 704 acquires the state information 10B of the user 100B via the server 107. The acquisition unit 704 is a communication device.

The object generation unit 705 generates the avatar 220B (image of the avatar 220B) whose position, attitude, expression and the like are controlled on the basis of the state information 10B.

The superposition unit 706 generates a camera synthesized image by superposing the avatar 220B on the picked-up image of the user 100A picked up by the imaging unit 701. At this time, the superposition unit 706 disposes the avatar 220B at a position (position in the picked-up image) according to the position of the user 100B indicated in the state information 10B. Specifically, in the camera synthesized image, the avatar 220B is disposed so that the relative position of the user 100B with respect to the camera 103B and the relative position of the avatar 220B with respect to the camera 103A are matched.

The recording unit 707 stores the camera synthesized image (image in which the avatar 220B is superposed on the picked-up image). In addition, the recording unit 707 may store the state information 10A and the range information 20A acquired by the detection unit 702.

### Detection Processing of Range Information

With reference to the flowchart in FIG. 9, the detection processing of the range information 20 executed by the detection unit 702 will be explained. In the following, such processing executed by the detection unit 702 of the camera 103A which picks up an image of the user 100A (real space 101A) will be explained.

At Step S901, the detection unit 702 detects an object (obstacle object) which would hinder movement of the user 100A from the image (picked-up image) of the user 100A picked up by the imaging unit 701. In FIG. 2A, the TV set 209 in the room 201 and the foliage plant 210 apply to the obstacle objects. In addition, the garden tree 211 and the dog 212 in the garden 202 apply to the obstacle objects.

Here, the detection unit 702 sets, as shown in FIG. 8, a three-dimensional coordinate space with the camera 103A position in the real space 101A as an origin (0, 0, 0). Then, the detection unit 702 detects the position and the size (a width W and a height H) of the obstacle object in the coordinate space concerned. Note that, in order to improve detection accuracy of the obstacle object, general recognition arts such as AI (Artificial Intelligence), DL (Deep Learning) and the like may be used.

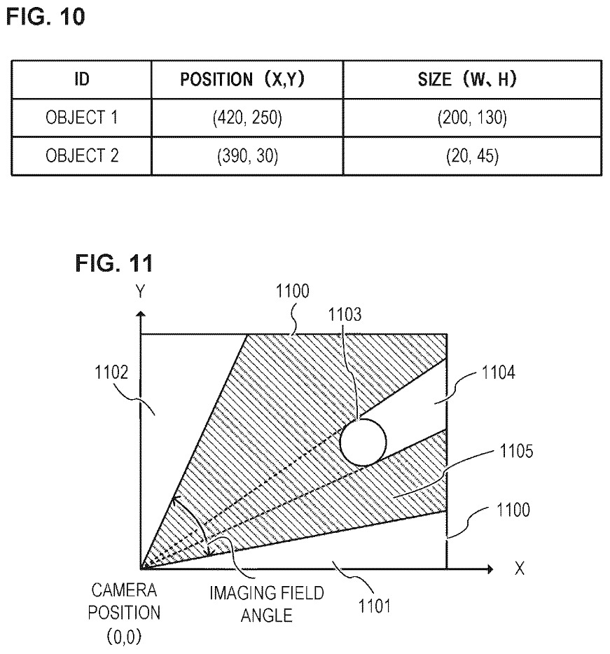

Then, the detection unit 702 generates a list indicating the position and the size (longitudinal and lateral lengths of the obstacle object when viewed from a Z-axis direction) of each of the obstacle objects as shown in FIG. 10 on the basis of the detection result of the detection object. Note that information on the position and the size of the obstacle object may be registered in advance by the user.

At Step S902, the detection unit 702 detects a range (effective range) in which the user 100A can move (move without being hindered by the obstacle object) in the real space 101A and the user 100A can be detected (can be imaged) by the camera 103A.

First, the detection unit 702 sets, as shown in FIG. 11, a two-dimensional coordinate space (two-dimensional coordinate space of the real space 101A viewed from the Z-axis direction in FIG. 8) with the position of the camera 103A in the real space 101A as an origin (0, 0). Then, the detection unit 702 acquires a range on the camera 103A side from a boundary line 1100 of the real space 101A (boundary line of a range in which the user 100A is movable; a wall and the like) in the range included in the imaging field angle of the camera 103A in the set coordinate space. Then, the detection unit 702 detects a range acquired by removing an object 1103 and a dead-angle range 1104 (range that cannot be visually recognized from the camera 103A due to the presence of the object 1103) from the acquired range as an effective range 1105 (range indicated by diagonal lines). Thus, the effective range 1105 does not include the dead-angle ranges 1101, 1102 on the right and left not included in the imaging field angle of the camera 103A. Note that the dead-angle range 1104 can be calculated by a known method from the position and the size of each of the obstacle objects shown in FIG. 10 (that is, the position and the size of the object 1103).

At Step S903, the detection unit 702 adds information related to the detection accuracy of the state of the user 100A (the position, attitude, expression and the like of the user 100A) in the imaging field angle of the camera 103A to the effective range detected at Step S902.

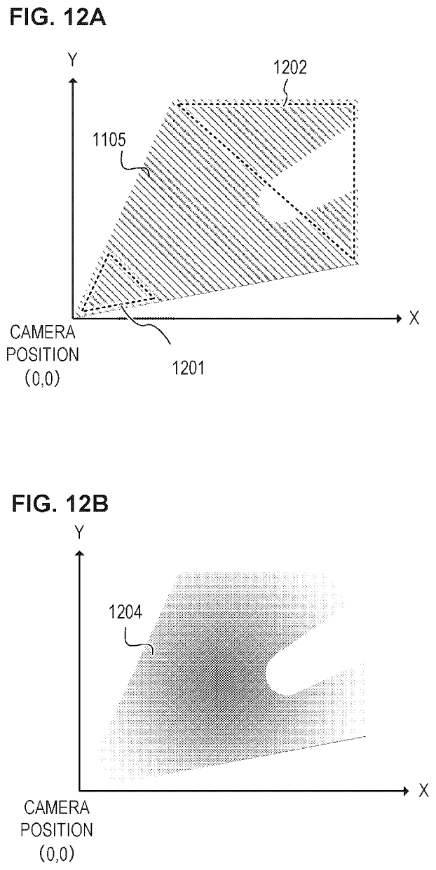

As shown in FIG. 12A, when the effective range 1105 has been detected, the user 100A can move freely inside the effective range 1105. However, in order for the camera 103A to accurately detect the state (position, attitude, expression of the face and the like) of the user 100A, an image of the entire body of the user 100A needs to be picked up with an appropriate size. For example, in a case where an image of the user 100A located in a range 1201 shown in FIG. 12A is to be picked up, since the user 100A is too close to the camera 103A, an image of only a part of the body of the user 100A can be picked up. Thus, the detection accuracy of the state of the user 100A by the detection unit 702 is lowered. In addition, in the case where the image of the user 100A located in a range 1202 is to be picked up, since the user 100A is too far from the camera 103A, the whole body of the user 100A is imaged smaller. Thus, in this case, too, the detection accuracy of the state of the user 100A is lowered.

As described above, the detection accuracy of the state of the user 100A becomes a value based on the size of the user 100A taken on the picked-up image and/or the range taken on the picked-up image in the whole body of the user 100A. Thus, the detection accuracy of the state of the actual user 100A gradually changes in accordance with a change in a distance between the position of the user 100A and the camera 103A. FIG. 12B illustrates the detection accuracy of the state of the user 100A corresponding to each coordinate of the effective range 1105 in FIG. 12A in the gradation display. A dark-color range in the gradation is a range in which the user 100A is movable and the detection accuracy of the state of the user 100A by the camera 103A is high. A pale-color range in the gradation is a range in which the user 100A is movable but the detection accuracy of the state of the user 100A by the camera 103A is low. Thus, if the user 100A is located in the pale-color range, there is a possibility that movement of the avatar 220A displayed on the HMD 102B is stopped or a possibility that the avatar 220A does not have a correct position or attitude.

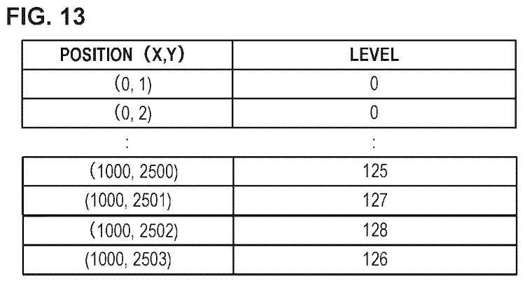

Thus, the detection unit 702 adds information related to the detection accuracy of the state of the user 100A to the effective range detected at Step S902 and outputs it as the range information 20A. Specifically, the detection unit 702 outputs information expressing the detection accuracy of the state of the user 100A at the respective coordinate positions in the gradation level (density) as shown in FIG. 13 as the range information 20A. Here, in FIG. 13, a position with the gradation level larger than a specific value (0, for example) is included in the effective range, while a position with the gradation level equal to or smaller than the specific value is not included in the effective range.

As shown at Steps S901 to S903, the detection unit 702 detects the effective range of the user 100A in the real space 101A from the picked-up image and transmits the range information 20A to the HMD 102B of the user 100B and the camera 103B. Then, the HMD 102B sets a coordinate space with the position of the camera 103B placed in the real space 101B as an origin on the basis of the range information 20A as shown in FIG. 8. The HMD 102B generates a range-display object such that the coordinate position (coordinate position of the coordinate space of the real space 101B) corresponding to each position of the effective range is colored in accordance with a gradation level of the position concerned of the effective range (the higher the gradation level is, the darker the color becomes). Then, the HMD 102B displays the range-display object together with the avatar 220A.

Thus, each position of the range-display object is displayed in such a display form according to the detection accuracy of the state of the user 100A at the coordinate position of the real space 101A corresponding to the position concerned. Note that each position of the range-display object does not have to be expressed in the gradation display but may be displayed in different colors according to the detection accuracy or may be displayed in patterns according to the detection accuracy, for example.

Note that, in this embodiment, the detection processing of the range information 20 indicating the two-dimensional coordinate space has been explained, but the range information 20 indicating the three-dimensional coordinate space to which the height direction of the real space was added may be detected. In addition, acquisition of the range information 20 usually needs to be performed only once at a timing to start display of the avatar 220.

As described above, according to the Embodiment 1, the user 100A can recognize the detection accuracy of the movement range of the avatar 220B and the state of the user 100B by looking at the information (range-display object) indicating the movement range of the avatar 220B of the other user 100B. Thus, the user 100A can grasp a possibility that the avatar 220B is disposed at an inappropriate position. And the user 100A can avoid disposition of the avatar 220A of the user 100A at an unnatural position in the image viewed by the user 100B by behaving within the range indicated by the range-display object. In addition, the user 100A can avoid unnatural movement of the avatar 220A of the user 100A in the image viewed by the user 100B by behaving within the range in dark color in the gradation display in the range-display object.

### Embodiment 2

In the Embodiment 2, the HMD 102 also displays a range in which the user 100 himself/herself wearing the HMD 102 is movable. In the following, explanation will be made by assuming that the HMD 102 is the HMD 102A worn by the user 100A.

In the Embodiment 1, the range in which the avatar 220B of the user 100B is movable was displayed on the HMD 102A. Here, when the video see-through type HMD 102A is to display an image of a virtual space (space, which is not a real space), there can be such cases that the user 100A plays with the avatar 220B in the virtual space or an image of a scene that they are playing is picked up. When the image of the virtual space is displayed on the HMD 102A, the user 100A cannot visually recognize the real space 101A in which the user himself/herself is located at present any more. Thus, when the user 100A is playing a game with movement by using the HMD 102A or the like, there is a risk that the user 100A collides against an obstacle object disposed in the real space 101A.

In order to avoid the above, the HMD 102A displays not only the movement range of the avatar 220B of the user 100B but also the range in which the user 100A is movable in the gradation display on the basis of the range information 20A detected by the camera 103A (superposed on the image of the virtual space). That is, the HMD 102A displays the range-display object indicating the range (range in the image of the virtual space) corresponding to the range in which the user 100A himself/herself is movable in the real space 101A. Note that the “range in which the user 100A is movable” in the Embodiment 2 may be the same range as the effective range of the user 100A. The “range in which the user 100A is movable” may be a range combining the effective area of the user 100A and the range that cannot be visually recognized from the camera 103A due to the presence of the obstacle object (dead-angle range 1104 in FIG. 11).

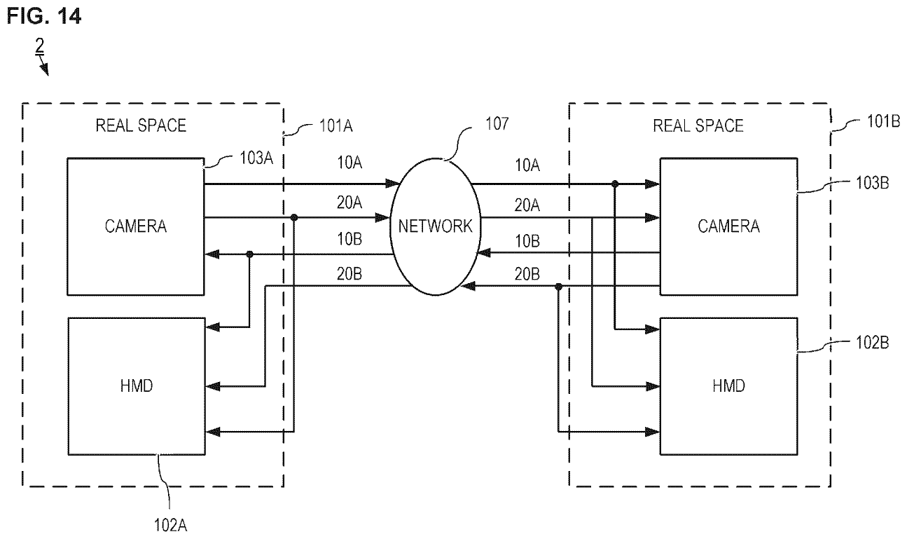

FIG. 14 illustrates a configuration of a system 2 in the Embodiment 2. The basic configuration of system 1 is similar to that of the system 2 according to the Embodiment 1. On the other hand, the HMD 102A acquires also the range information 20A of the user 100A in order to know the range in which the user 100A himself/herself wearing the HMD 102A is movable.

The HMD 102A according to the Embodiment 2 is similar to the see-through type HMD 500 (FIG. 5), but the object generation unit 503 generates a range-display object indicating a movable range for each of the two pieces of the range information 20A and 20B. The HMD 102A may display the two range-display objects by individually switching at a certain time interval or may display them simultaneously in gradations in different colors.

As a result, the user 100A can recognize the range in which both the user 100A himself/herself and the avatar 220B can move. Thus, the user 100A can avoid such a risk of colliding against the obstacle object.

Note that, in the Embodiment 2, in an example, it is assumed that avatars of the both users are displayed in the virtual space by using the video see-through type HMD, but only the HMD of either one of the users may be the video see-through type HMD.

Note that the HMD (display device) in each of the aforementioned Embodiments may be constituted by the control device that controls the HMD (configuration of the HMD 500 from which the display unit 505 is removed, for example) and the display unit (the display unit 505 in the HMD 500, for example).

According to the present invention, when a virtual object is to be disposed in accordance with a position of a user, a possibility that the virtual object is disposed at an inappropriate position can be grasped.

In addition, in the above, the phrase “when A is equal to or larger than B, processing proceeds to Step S1, and when A is smaller (lower) than B, the processing proceeds to Step S2” may read “when A is larger (higher) than B, processing proceeds to Step S1, and when A is equal to or smaller than B, the processing proceeds to Step S2”. To the contrary, the phrase “when A is larger (higher) than B, processing proceeds to Step S1, and when A is equal to or smaller than B, the processing proceeds to Step S2” may read “when A is equal to or larger than B, processing proceeds to Step S1, and when A is smaller (lower) than B, the processing proceeds to Step S2”. Thus, unless otherwise contradicted, the expression of “equal to or larger than A” may be replaced with “A or larger (higher; longer; more) than A”, or may read or may be replaced with “larger (higher; longer; more) than A”. On the other hand, the expression of “equal to or smaller than A” may be replaced with “A or smaller (lower; shorter; less) than A”, or may read or may be replaced with “smaller (lower; shorter; less) than A”. And the phrase “larger (higher; longer; more) than A” may read “equal to or larger than A”, and the phrase “smaller (lower; shorter; less) than A” may read “equal to or less than A”.

Whereas the present invention has been described with reference to the preferred embodiments thereof, the present invention is not limited to these specific embodiments, and includes various forms in a scope not departing from the spirit of the invention. The above embodiments may be partially combined with each other if required.

The above processors are processors in the broadest sense and include both general purpose and specialized processors. The general-purpose processors include, for example, CPU (Central Processing Unit), MPU (Micro Processing Unit), and DSP (Digital Signal Processor). The specialized processors include, for example, GPU (Graphics Processing Unit), ASIC (Application Specific Integrated Circuit), PLD (Programmable Logic Device), etc. The programmable logic devices are, for example, FPGA (Field Programmable Gate Array), CPLD (Complex Programmable Logic Device), etc.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention is not limited to the embodiments described above, but may be changed and modified in various ways without departing from the spirit and scope of the present invention. Therefore the following claims will be attached to disclose the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A control device for controlling a display device to be worn by a first user in a first real space, the control device comprising one or more processors and/or circuitry configured to:
execute control processing of controlling the display device such that a virtual object disposed at a position in the first real space corresponding to a position of a second user in a second real space and a range-display object indicating a range, in which the virtual object is movable in the first real space, are displayed, wherein
the range, in which the virtual object is movable in the first real space, corresponds to an effective range; and
the effective range is a range in which the second user is movable in the second real space and in which the second user is detectable from a picked-up image acquired by an imaging device through imaging in the second real space.

2. The control device according to claim 1, wherein
in the control processing, in the range-display object, each position in a range, in which the virtual object is movable in the first real space, is displayed in a display form according to detection accuracy of a state of the second user at a position in the second real space corresponding to the position concerned.

3. The control device according to claim 2, wherein
detection accuracy of a state of the second user is accuracy based on at least either one of a range reflected in the picked-up image of a whole body of the second user and a size of the second user in the picked-up image.

4. The control device according to claim 1, wherein the one or more processors and/or circuitry is further configured to:
execute acquisition processing of acquiring range information indicating the effective range; and
generation processing of generating the range-display object on a basis of the range information.

5. The control device according to claim 4, wherein
in the acquisition processing, state information indicating a state of the second user including the position of the second user is further acquired; and
in the generation processing, the virtual object is generated on a basis of the state information.

6. The control device according to claim 1, wherein
the display device is a display device capable of visual recognition of an outside through a display; and
in the control processing, the display device is controlled such that the virtual object and the range-display object are displayed on the display.

7. The control device according to claim 1, wherein
in the control processing, the display device is controlled such that an image, in which the virtual object and the range-display object are synthesized with a pick-up image of a front of the first user, is displayed.

8. The control device according to claim 1, wherein
in the control processing, the display device is controlled such that an image of a virtual space is displayed, and a third image indicating a range corresponding to a range, in which the first user is movable in the first real space, and indicating a range in an image of the virtual space is further displayed.

9. A system comprising:
the control device according to claim 1; and
an imaging device that acquires a picked-up image by imaging the second real space.

10. The system according to claim 9, the system comprising one or more processors and/or circuitry, configured to execute detection processing of detecting the effective range on a basis of the picked-up image.

11. A control method for controlling a display device to be worn by a first user in a first real space, the method comprising:
a first control step of controlling the display device such that a virtual object disposed at a position of the first real space corresponding to a position of a second user in a second real space is displayed; and
a second control step of controlling the display device such that a range-display object indicating a range, in which the virtual object is movable in the first real space is displayed, wherein
the range, in which the virtual object is movable in the first real space, corresponds to an effective range; and
the effective range is a range, in which the second user is movable, in the second real space and, in which the second user is detectable from a picked-up image acquired by imaging by the imaging device, in the second real space.

12. A non-transitory computer readable medium that stores a program, wherein the program causes a computer to execute a control method for controlling a display device to be worn by a first user in a first real space, the control method comprising:
a first control step of controlling the display device such that a virtual object disposed at a position of the first real space corresponding to a position of a second user in a second real space is displayed; and
a second control step of controlling the display device such that a range-display object indicating a range in which the virtual object is movable in the first real space is displayed, wherein
the range in which the virtual object is movable in the first real space corresponds to an effective range; and
the effective range is a range, in which the second user is movable, in the second real space and, in which the second user is detectable from a picked-up image acquired by imaging by the imaging device, in the second real space.
